(19) United States
(12) Patent Application Publication
(10) Pub. No.: US 2013/0229910 A1
(43) Pub. Date: Sep. 5, 2013

(54) SYSTEM, METHOD, APPARATUS, AND COMPUTER PROGRAM PRODUCT FOR PROVIDING NETWORK CONNECTIVITY

(71) Applicants: Thomas R. McKnight, JR., Ellicott City, MD (US); Rudy Yukich, Columbia, MD (US)

(72) Inventors: Thomas R. McKnight, JR., Ellicott City, MD (US); Rudy Yukich, Columbia, MD (US)

(73) Assignee: VISUAL TELEHEALTH SYSTEMS, INC., Bethesda, MD (US)

(21) Appl. No.: 13/409,861

(22) Filed: Mar. 1, 2012

(51) Int. Cl. H04W 84/18; H04W 24/00; H04W 84/22; H04W 28/08

(52) U.S. Cl. 370/218; 370/255; 370/250

(57) ABSTRACT

A method for providing network connectivity is provided. The method may include interfacing with a wireless mesh network. The method may further include interfacing with one or more network link devices configured to establish a wireless connection to an external network. The method may additionally include routing outbound traffic received via the mesh network and intended for a destination accessible via the external network toward a selected one of the one or more bridge nodes for delivery via the external network. The method may also include routing inbound traffic received via one of the one or more bridge nodes from the external network toward a destination accessible via the mesh network. A corresponding system, apparatus, and computer program product are also provided.

### FEDERALLY SPONSORED RESEARCH OR DEVELOPMENT

This invention was made with United States Government support under Subcontract No. P010064752 awarded by Science Applications International Corporation under Prime Contract No. DAAD05-99-D-7015 awarded by the Air Force Research Laboratory. The United States Government has certain rights in the invention.

### TECHNOLOGICAL FIELD

Embodiments of the present invention relate generally to computer networking and communication technology and, more particularly, relate to a system, method, apparatus, and computer program product for providing network connectivity.

### BACKGROUND

Local area networks are often implemented at business facilities to enable communication among computing devices within the facility, as well as to provide access network resources by the networked computing devices. However, while local area networks may support local communication among computing devices and access to local resources, access to external network services and computing devices accessible via a Wide Area Networks (WAN), such as the Internet, require a connection to the Internet. As an example, a computing device in a health care facility may require Internet access to access an electronic medical record, submit an insurance claim, and/or the like.

While facilities may have wired connectivity to the Internet, such wired connectivity is often bandwidth limited, and upgrading a facility to include additional wired connectivity may prove costly, at best, and in some instances may not be possible. In this regard, provisioning wireline Internet connectivity throughout a facility is often an expensive process requiring extensive planning, physical wiring work, telecommunications provider cooperation, and deployment of network infrastructure. Also, establishing a physical connection to the Internet is not even possible in some remote locations. Moreover, in situations, such as disaster recovery scenarios, physical network connectivity infrastructure may be unavailable, or even destroyed. Accordingly, providing physical connectivity to the Internet having sufficient bandwidth to handle traffic may be difficult, if not impossible, in many circumstances.

Several wireless network access technologies have been developed that may provide relatively high-bandwidth access to the Internet. For example, a variety of cellular networking technologies, satellite technology, and the like enable computing devices to wirelessly access a WAN for purposes of accessing network services and communicating with other computing devices over the WAN. However, the ability to use wireless access technologies within facilities to access the Internet is often limited, as barriers, such as walls, within facilities may impact the range and quality of the wireless signals used by wireless network access technologies. Accordingly, the placement of devices within a facility may be limited to only a few locations within the facility, thus limiting the ability to leverage wireless network access technologies.

### BRIEF SUMMARY OF EXAMPLE EMBODIMENTS

Systems, methods, apparatuses and computer program products are provided herein for providing network connectivity. Embodiments provided herein may provide several advantages to network providers, businesses, computing devices, and computing device users. For example, some example embodiments provide for bridging a wireless mesh network and an external network. In this regard, some such example embodiments provide a routing apparatus configured to interface with the wireless mesh network and to interface with one or more network link devices configured to establish a wireless connection to the external network such that the routing apparatus may route traffic from the mesh network to the external network, and from the external network to a destination accessible via the mesh network.

Accordingly, some example embodiments allow networking infrastructure, including Internet connectivity to be rapidly deployed to a new location with little to no site planning. More particularly, the mesh network may adapt to radio propagation opportunities and conditions, while the routing apparatus may leverage whatever connection(s) to the Internet, or other external network, may be available via the network link device(s). In this regard, some example embodiments provide a bridge between local high-bandwidth wireless communications over the mesh network and a cellular data infrastructure and/or other wireless access to an external network, such as the Internet. Thus, example embodiments may provide a significant reduction in the expense and effort to deploy network connectivity to a site, as the use of wireless mesh networking technologies in combination with cellular and/or other wireless access technologies for connecting to an external network may significantly reduce the time and cost needed for deploying a network infrastructure as compared to wired networks.

Some such example embodiments may be particularly ideal for quickly and unobtrusively providing internet connectivity at medical facilities, in which widespread deployment of wired networks may not be feasible due to facility size and layout, as well as due to the use of mobile computing devices by clinicians to facilitate mobility through the facility when visiting patients. Further, some such example embodiments may be rapidly deployed during disaster or other emergency operations in which wired network connectivity may be unavailable, and response teams may need to quickly deploy network infrastructure to support response operations. As another example, some such example embodiments may be used in military field operations to enable rapid on-the-fly deployment of a network infrastructure to support operations.

In a first example embodiment, a method for bridging a wireless mesh network and an external network is provided. The method of this example embodiment may comprise interfacing with the wireless mesh network. The method of this example embodiment may further comprise interfacing with one or more network link devices configured to establish a wireless connection to the external network. The method of this example embodiment may also comprise routing outbound traffic received via the mesh network and intended for a destination accessible via the external network toward a selected one of the one or more bridge nodes for delivery via the external network. The method of this example embodiment may additionally comprise routing inbound traffic received via one of the one or more bridge nodes from the external network toward a destination accessible via the mesh network.

In another example embodiment, an apparatus for bridging a wireless mesh network and an external network is provided. The apparatus of this example embodiment may comprise processing circuitry that may be configured to cause the apparatus of this example embodiment to interface with the wireless mesh network. The processing circuitry may be further configured to cause the apparatus of this example embodiment to interface with one or more network link devices configured to establish a wireless connection to the external network. The processing circuitry may be additionally configured to cause the apparatus of this example embodiment to route outbound traffic received via the mesh network and intended for a destination accessible via the external network toward a selected one of the one or more bridge nodes for delivery via the external network. The processing circuitry may also be configured to cause the apparatus of this example embodiment to route inbound traffic received via one of the one or more bridge nodes from the external network toward a destination accessible via the mesh network.

In a further example embodiment, a computer program product for bridging a wireless mesh network and an external network is provided. The computer program product of this example embodiment may comprise at least one non-transitory computer-readable storage medium having computer-readable program code instructions stored therein. The computer-readable program code instructions of this example embodiment may include program code instructions configured to cause an apparatus to interface with the wireless mesh network. The computer-readable program code instructions of this example embodiment may further include program code instructions configured to cause the apparatus to interface with one or more network link devices configured to establish a wireless connection to the external network. The computer-readable program code instructions of this example embodiment may also include program code instructions configured to cause the apparatus to route outbound traffic received via the mesh network and intended for a destination accessible via the external network toward a selected one of the one or more bridge nodes for delivery via the external network. The computer-readable program code instructions of this example embodiment may additionally include program code instructions configured to cause the apparatus to route inbound traffic received via one of the one or more bridge nodes from the external network toward a destination accessible via the mesh network.

In yet another example embodiment, an apparatus for bridging a wireless mesh network and an external network is provided. The apparatus of this example embodiment may comprise means for interfacing with the wireless mesh network. The apparatus of this example embodiment may further comprise means for interfacing with one or more network link devices configured to establish a wireless connection to the external network. The apparatus of this example embodiment may also comprise means for routing outbound traffic received via the mesh network and intended for a destination accessible via the external network toward a selected one of the one or more bridge nodes for delivery via the external network. The apparatus of this example embodiment may additionally comprise means for routing inbound traffic received via one of the one or more bridge nodes from the external network toward a destination accessible via the mesh network.

In still a further example embodiment, a system for providing network connectivity is provided. The system of this example embodiment may comprise a plurality of wireless mesh nodes configured to form a wireless mesh network. The system of this example embodiment may additionally comprise one or more network link devise configured to establish a wireless connection to an external network. The system of this example embodiment may also comprise a routing apparatus. The routing apparatus of this example embodiment may be configured to interface with the wireless mesh network. The routing apparatus of this example embodiment may be further configured to interface with the one or more network link devices. The routing apparatus of this example embodiment may also be configured to route outbound traffic received via the mesh network and intended for a destination accessible via the external network toward a selected one of the one or more network link devices for delivery via the external network. The routing apparatus of this example embodiment may additionally be configured to route inbound traffic received via one of the one or more network link devices from the external network toward a destination accessible via the mesh network.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for providing network connectivity according to some example embodiments;

FIG. 2 illustrates a block diagram of a routing apparatus for bridging a wireless mesh network and an external network in accordance with some example embodiments;

FIG. 3 illustrates a flowchart according to an example method for bridging a wireless mesh network and an external network according to some example embodiments;

FIG. 4 illustrates a flowchart according to an example method for routing outbound traffic according to some example embodiments; and

FIG. 5 illustrates a flowchart according to an example method for performing fail over according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

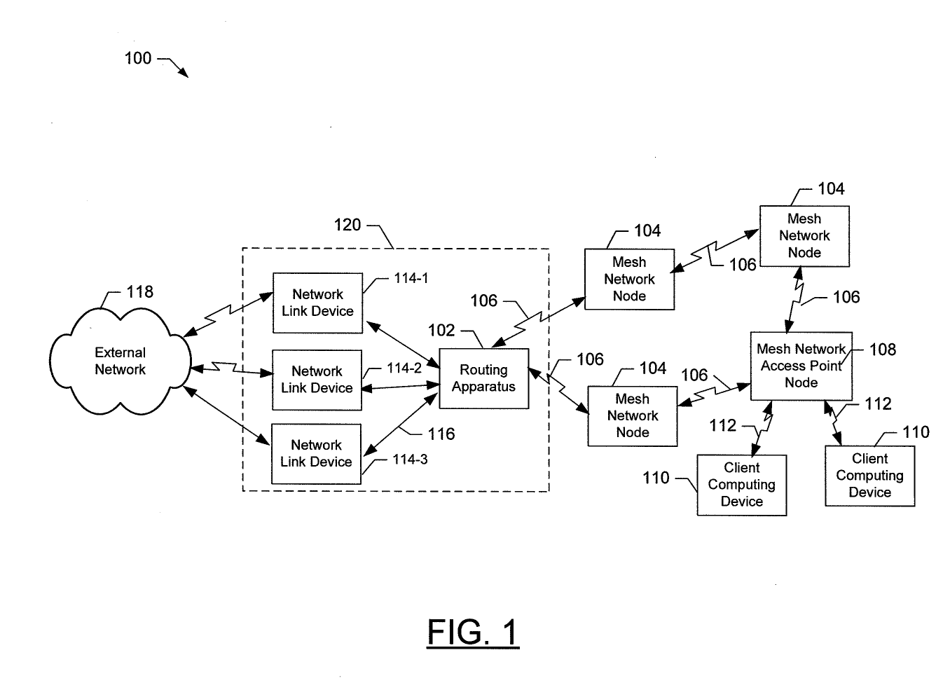

FIG. 1 illustrates a system 100 for providing network connectivity according to some example embodiments. It will be appreciated that the system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing network connectivity, numerous other configurations may also be used to implement embodiments of the present invention.

The system 100 may include a routing apparatus 102. The routing apparatus 102 be configured to interface with a wireless mesh network via one or more wireless connections 106 to one or more nodes (for example, a mesh network node 104, mesh network access point node 108, and/or the like) of the wireless mesh network. In this regard, the routing apparatus 102 may, itself, comprise a node of the mesh network. The routing apparatus 102 may be further configured to interface with one or more network link devices 114, such as via one or more connections 116. As will be described further herein below, the routing apparatus 102 may be configured to operate as a central router, load balancer, and traffic shaper to provide routing services for routing inbound traffic received from the external network 118 via a network link device 114 to a destination accessible via the mesh network, and to route outbound traffic received via the mesh network toward a network link device 114 so that it may be delivered to a destination on an external network 118. In some example embodiments, the routing apparatus 102 may be configured to provide mesh extension services for extending a range of the mesh network. The routing apparatus 102 may additionally be configured in some example embodiments to provide Dynamic Host Control Protocol (DHCP services to the mesh network and/or to the network link device(s) 114.

The routing apparatus 102 may be embodied as any computing device configured to interface both with a wireless mesh network and with one or more network link devices 114 and provide routing services in accordance with one or more example embodiments. By way of non-limiting example, the routing apparatus 102 may comprise a router, embedded computing device, desktop computer, laptop computer, chipset, a computing device comprising a chipset, any combination thereof, and/or the like. In some example embodiments, the routing apparatus 102 may comprise a plurality of computing devices in communication with each other that may be collectively configured to perform the functionality of a routing apparatus 102 in accordance with one or more example embodiments. In some example embodiments, the routing apparatus 102 may comprise an embedded Linux device, which may be configured to leverage routing capabilities of the Linux kernel in accordance with routing policy configurations in accordance with one or more example embodiments. In some example embodiments, the routing apparatus 102 may comprise a fan-less personal computer having a relatively small form factor that is configured to interface with both a mesh network and with one or more network link devices, and to provide routing services in accordance with one or more example embodiments.

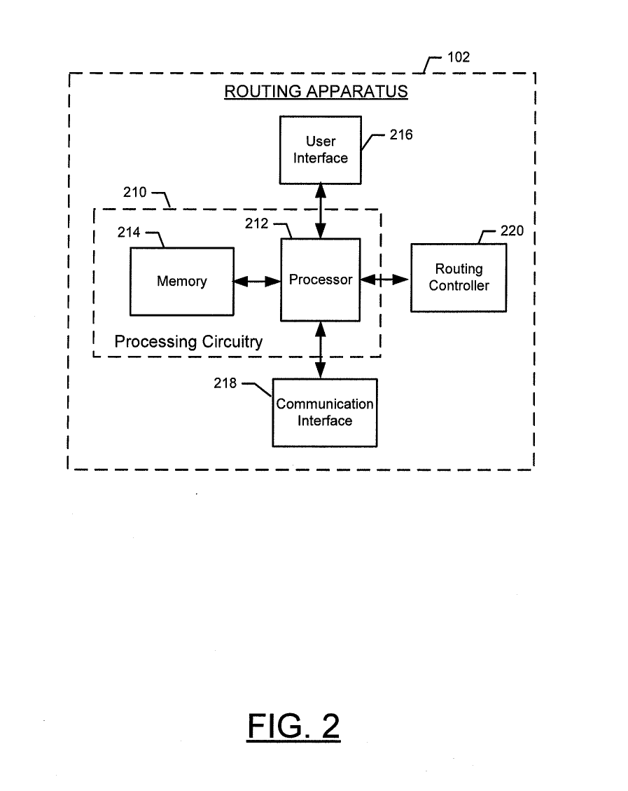

FIG. 2 illustrates a block diagram of a routing apparatus 102 for bridging a wireless mesh network and an external network(s) (e.g., the external network 118) in accordance with some example embodiments. However, it should be noted that the components, devices or elements illustrated in and described with respect to FIG. 2 below may not be mandatory and thus some may be omitted in certain embodiments. Additionally, some embodiments may include further or different components, devices or elements beyond those illustrated in and described with respect to FIG. 2.

Referring now to FIG. 2, the routing apparatus 102 may include or otherwise be in communication with processing circuitry 210 that is configurable to perform actions in accordance with one or more example embodiments disclosed herein. In this regard, the processing circuitry 210 may be configured to perform and/or control performance of one or more functionalities of the routing apparatus 102 in accordance with various example embodiments, and thus may provide means for performing functionalities of the routing apparatus 102 in accordance with various example embodiments. The processing circuitry 210 may be configured to perform data processing, application execution and/or other processing and management services according to one or more example embodiments. In some embodiments, the routing apparatus 102 or a portion(s) or component(s) thereof, such as the processing circuitry 210, may be embodied as or comprise a chip or chip set. In other words, the routing apparatus 102 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The routing apparatus 102 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, a communication interface 218, and/or a routing controller 220. As such, the processing circuitry 210 may be embodied as a circuit chip (e.g., an integrated circuit chip) configured (e.g., with hardware, software or a combination of hardware and software) to perform operations described herein.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the routing apparatus 102 as described herein. The plurality of processors may be embodied on a single computing device or distributed across a plurality of computing devices collectively configured to function as the routing apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the routing apparatus 102. The memory 214 may be configured to store information, data, applications, instructions or the like for enabling the routing apparatus 102 to early out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents or data sets. Among the contents of the memory 214, applications may be stored for execution by the processor 212 in order to carry out the functionality associated with each respective application. In some cases, the memory 214 may be in communication with one or more of the processor 212, user interface 216, communication interface 218, or routing controller 220 via a bus(es) for passing information among components of the routing apparatus 102.

The user interface 216 (if implemented) may be in communication with the processing circuitry 210 to receive an indication of a user input at the user interface 216 and/or to provide an audible, visual, mechanical or other output to the user. As such, the user interface 216 may include, for example, a keyboard, a mouse, a joystick, a display, a touch screen, a microphone, a speaker, and/or other input/output mechanisms. As such, the user interface 216 may, in some example embodiments, provide means for user configuration of routing policies, user monitoring of network status, and/or the like. It will be appreciated, however, that in some example embodiments, such as in some example embodiments wherein the routing apparatus 102 may be implemented on a dedicated routing device, embedded device, or the like, aspects of the user interface 216 may be limited, or the user interface 216 may even be omitted.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the routing apparatus 102 to interface with a mesh network (for example, with a mesh network node 104, mesh network access point node 108, and/or the like via one or more wireless connections 106). As another example, the communication interface 218 may be configured to enable the routing apparatus 102 to interface with one or more network link devices 114, such as via one or more connections 116. In this regard, the communication interface 218 may include, for example, an antenna (or multiple antennas) and supporting hardware and/or software for enabling communications with a wireless communication network (e.g., a mesh network) and/or a communication modem or other hardware/software for supporting communication via cable, digital subscriber line (DSL), universal serial bus (USB), Ethernet or other methods.

In some example embodiments, the processor 212 (or the processing circuitry 210) may be embodied as, include, or otherwise control a routing controller 220. As such, the routing controller 220 may be embodied as various means, such as circuitry, hardware, a computer program product comprising computer readable program instructions stored on a computer readable medium (for example, the memory 214) and executed by a processing device (for example, the processor 212), or some combination thereof. The routing controller 220 may be capable of communication with one or more of the memory 214, user interface 216, or communication interface 218 to access, receive, and/or send data as may be needed to perform one or more of the functionalities of the routing controller 220 as described herein. In some example embodiments, the routing controller 220 may be configured to implement routing policies for load balancing, traffic shaping, performing failover between network link devices 114, and/or the like, as will be described further herein below.

A mesh network with which the routing apparatus 102 may interface may comprise any mesh communications network comprising a set of radio nodes which are capable of routing traffic from one node to another node even if the two nodes do not have a direct link between them. In this regard, mesh nodes (for example, a mesh network node 104, mesh network access point node 108, routing apparatus 102, and/or the like) may repeat traffic that they hear for destinations that cannot directly hear the originating node, thus hopping the traffic from node-to-node until the destination is reached. For example, the routing apparatus 102 and mesh network access point 108 may be positioned outside of a range of a wireless communications technology that may be used for mesh communications. However, traffic may be passed between the routing apparatus 102 and mesh network access point node 108 via a plurality of wireless connections 106 between intermediate mesh network nodes 104. Accordingly, mesh nodes may be readily deployed in an ad hoc fashion so as to add a node to the mesh network, extend a coverage range of the mesh network, and/or the like.

The mesh network may comprise a variety of nodes. As already discussed, the routing apparatus 102 may, itself, comprise a mesh node. The mesh network may further comprise one or more mesh network nodes 104. A mesh network node 104 may comprise any computing device configured to function as a node of a mesh network to send, receive, and repeat traffic via the mesh network. By way of non-limiting example, a mesh network node 104 may comprise a router, bridge device, wireless range extending device, repeating device, desktop computer, laptop computer, mobile computing device, tablet computing device, a cellular phone, some combination thereof, or the like configured to function as a mesh node. In some embodiments, a mesh network node 104 may comprise a dedicated mesh network node that may function solely to extend a range of the mesh network, and/or otherwise support the mesh network so that one or more additional nodes may interface with the mesh network. Additionally or alternatively, in some embodiments a mesh network node 104 may comprise a mesh-enabled end-user device, such as a desktop computer, laptop computer, mobile computing device, tablet computing device, a cellular phone, and/or the like that may be used by an end user to perform tasks. For example, a tablet computing device may have mesh drivers installed, and may behave as an integral part of the mesh network, and may even extend the range of the mesh network.

In some example embodiments, the mesh network may comprise one or more mesh network access point nodes 108 in addition to, or in lieu of, mesh network nodes 104. A mesh network access point node 108 may comprise a wireless network access point that may be configured to provide an infrastructure Wireless Local Area Network (WLAN) access point, such as in accordance with an Institute of Electrical and Electronics Engineers (IEEE) 802.11 standard. A mesh network access point node 108 may operate in a dual mode to communicate via a wireless mesh protocol with other mesh network nodes, while also serving as a managed infrastructure WLAN access point. Thus, a mesh network access point node 108 may operate in both “ad hoc” mode to talk directly with peer nodes in the mesh network (e.g., other mesh network access point nodes 108, mesh network nodes 104, the routing apparatus 102, and/or the like) and in “infrastructure” mode to provide a central access point to one or more client computing devices 110. In order to support simultaneous operation in both ad hoc and infrastructure modes, a mesh network access point node 108 in accordance with some example embodiments may be configured to use device radio(s) simultaneously in both ad hoc and infrastructure mode by using virtual interfaces.

A wireless mesh network access point node 108 may accordingly be configured to provide a structured WLAN access point to one or more client computing devices 110 via a WLAN communication link 112 so as to enable a connected client computing device 110 to send and receive data over the mesh network. A client computing device 110 may, for example, comprise a laptop computer, desktop computer, tablet computing device, smart phone, and/or the like that may be configured to connect to a WLAN access point. In this regard, through deployment of one or more mesh network access point nodes 108 the mesh network may appear to an end user device (e.g., a client computing device 110) as a standard 802.11, or other WLAN, network. Accordingly, mesh network access point nodes 108 may enable a variety of existing devices to utilize network connectivity provided in accordance with various example embodiments without modification. The WLAN network that may be presented to a client computing device 110 may, for example, comprise a Wi-Fi Protected Access (WPA)-protected network.

Some mesh nodes (e.g., a mesh network node 104, mesh network access point node 108, and/or the like) may also provide for direct wired connectivity with a client computing device 110, such as via Ethernet, USB, and/or the like. Accordingly, computers, printers, or network appliances which do not have built-in WLAN capability may also join the mesh network with a wired connection. For example, a wired Ethernet hub may be connected to a mesh node to create an “island” of wired network access.

The core of the mesh network may accordingly be composed of mesh-capable access points (for example, mesh network access point nodes 108) and/or mesh-capable devices (for example, mesh network nodes 104), which may comprise peers within the mesh. One or more client devices (e.g., one or more client computing devices 110) may be coupled to the mesh network via infrastructure mode WLAN access that may be provided by an access point (e.g., a mesh network access point node 108) operating in a mixed mesh and infrastructure mode. Additionally or alternatively, one or more client devices may be coupled to the mesh network via a wired (e.g., Ethernet) connection to a mesh network node.

Authorized computing devices (e.g., mesh network nodes 104, mesh network access point nodes 108, client computing devices 110, and/or the like) participating in and/or otherwise coupled to the mesh network may be provided with DHCP services by the routing apparatus 102. In this regard, routing apparatus 102 may provide Domain Name System (DNS) information to connected computing devices, and may inform the connected computing devices that the routing apparatus 102 is a gateway to the external network 118.

The mesh-capable nodes of the mesh network (e.g., the routing apparatus 102, mesh network node 104, mesh network access point node 108, and/or the like) may be configured via specially configured circuitry, firmware, and/or the like to implement a mesh protocol that may be used for communications over the mesh network. For example, in some example embodiments, mesh-capable nodes may be configured with customized embedded Linux firmware to implement a mesh protocol in accordance with one or more example embodiments. It will be appreciated that mesh-capable nodes in accordance with various example embodiments may implement any appropriate mesh protocol, and may utilize any appropriate wireless signaling technology or standard to implement the wireless connections 106 for conveying traffic over the mesh network.

In some example embodiments, mesh-capable nodes (e.g., the routing apparatus 102, mesh network node 104, mesh network access point node 108, and/or the like) may be configured to implement the BATMAN (Better Approach To Mesh Ad-hoc Networking) Advanced protocol. A BATMAN node may be configured to operate in Wi-Fi ad-hoc mode, and run specially-configured BATMAN software. The BATMAN software may be configured to broadcast the node's existence via announcements to surrounding nodes which are within range, and rebroadcast received announcements from other nodes, with safeguards in place to prevent broadcast loops. The result of the broadcast and re-broadcast announcements may be that mesh nodes learn of the presence and next hop to every other node on the network. To client devices (e.g., a client computing device 110), the BATMAN Advanced mesh may look like a Layer 2 Ethernet network switch. In some example embodiments, any device on the mesh may talk to any other device on the mesh using Ethernet frames (e.g., frames enclosing TCP/IP or other traffic), just as if they were plugged into the same wired Ethernet network hub.

While some example embodiments have been described to use BATMAN protocol, it will be appreciated that any appropriate mesh protocol may be used in addition to or in lieu of BATMAN in accordance with various example embodiments. For example, Babel, DSDV (Highly Dynamic Destination-Sequenced Distance Vector routing protocol), HSR (Hierarchical State Routing Protocol), IARP (Intrazone Routing Protocol), LCA (Linked Cluster Architecture), WAR (Witness Aided Routing), OLSR (Optimized Link State Routing Protocol), Meraki mesh protocol, and/or the like may be used in addition to or in lieu of BATMAN in accordance with some example embodiments.

As previously described, in various example embodiments, the routing apparatus 102 may be configured to interface with one or more network link devices 114. While three such network link devices 114 are illustrated in FIG. 1, it will be appreciated that this illustration is by way of example, and not by way of limitation, as the system 100 may be scaled in accordance with various example embodiments to include fewer or additional network link devices 114. A network link device 114 may comprise any comprise any device configured to establish a connection to the external network 118. The external network 118 may comprise one or more WANs and may, for example, comprise a wireline network, wireless network (e.g., a cellular network, wireless wide area network, some combination thereof, or the like), or a combination thereof, and in one embodiment comprises the Internet.

A network link device 114 may be configured to use any of a variety of network access technologies to establish a connection to the external network 118. In some example embodiments, one or more network link devices (e.g., the network link device 114-1 and network link device 114-2 illustrated in FIG. 1) may use one or more wireless network access technologies to establish a connection to the external network 118. By way example, a network link device 114 may comprise a cellular bridge device that may be configured to use any of a variety of Third-Generation (3G), Fourth-Generation (4G), and/or future generation cellular access protocols to establish a connection to the external network 118. Such cellular network access protocols may, for example, include EV-DO (Evolution-data optimized), HSPA (High Speed Packet Access), GPRS (General Packet Radio Service), LTE (Long Term Evolution), LTE-A (Long Term Evolution-Advanced), 4G WiMAX (Worldwide Interoperability for Microwave Access), an/or the like. As another example, a network link device 114 may comprise a satellite communication device that may be configured to establish a connection to the external network 118 via a satellite link. As such, it will be appreciated that a network link device 114 may comprise any circuitry, computing device, bridge, modem, and/or the like that may be configured to use a wireless network access technology to establish a wireless connection to the external network 118.

A network link device 114 in accordance with some example embodiments may comprise a device including a bank of a plurality of modems (for example, cellular modems), each of which may be configured to establish a wireless connection to the external network 118. The routing apparatus 102 may view a network link device 114 including a bank of modems as providing a single connection to the external network 118, and failover servicing among the bank of modems may be handled by the network link device, itself.

In some example embodiments, one or more network link devices (e.g., the network link device 114-3 illustrated in FIG. 1) may use one or more wireline network access technologies to establish a connection to the external network 118. For example, a network link device may comprise a digital subscriber line modem, cable modem, and/or the like, which may be configured to establish a connection to an external network via a wireline network access technology. It will be appreciated, however, that while some example embodiments may include a mixed deployment of network link devices 114 (e.g., network link devise 114-1 and 114-2) configured to establish a connection via a wireless access technology and a network link device (e.g., the network link device 114-3) configured to establish a connection via a wireline access technology, embodiments are not limited to such mixed deployments. In this regard, for example, in some deployments, the routing apparatus 102 may only be interfaced with one or more network link devices 114 configured to use a wireless network access technology(ies) to establish a connection to an external network. Alternatively, as another example, in some deployments, the routing apparatus 102 may only be interfaced with one or more network link devices 114 configured to use a wireline network access technology(ies) to establish a connection to an external network.

In some example embodiments, a network link device 114 may be interfaced with the routing apparatus 102, such as on a plug-and-play basis, via a connection 116. When a network link device 114 is powered on (if necessary) and interfaced with the routing apparatus 102 via a connection 116, the routing apparatus 116 may detect the network link device, and may route outbound traffic toward the network link device in accordance with routing policies that may be implemented on the routing apparatus 102.

A connection 116 may, for example, comprise a connection via the mesh network. In this regard, in some example embodiments, one or more network link devices 114 may comprise mesh nodes, which may interface with the mesh network. Accordingly, for a network link device 114 that comprises a mesh node, the routing apparatus 102 may be configured to route outbound traffic toward the mesh-enabled network link device over the mesh network and/or receive inbound traffic from the mesh-enabled network link device over the mesh network. In some deployments, the use of mesh-enabled network link devices 114 may relieve constraints on placement of the routing apparatus 102. For example, a mesh-enabled network link device including a 3G cellular modem may be placed near a window for optimal reception, while routing apparatus 102 may be placed in a central wiring closet. As another example, a mesh-enabled network link device including a 4G WiMAX modem may be placed on a top floor of a facility in which the system 100 may be deployed to provide for optimal reception. In this regard, as long as a mesh-enabled node is within range of another mesh node and has access to a power supply, placement of a mesh-enabled network link device may be flexible so as to account for placement concerns attendant to the relevant network access technology.

As another example, a connection 116 may comprise a wired connection (e.g., a USB connection, Ethernet connection, and/or the like), which may physically couple a network link device 114 to the routing apparatus 102. As still a further example, a network link device 114 may be integrated into and/or otherwise implemented on a routing apparatus 102, and thus a connection 116 may comprise a bus and/or other internal link that may physically couple an integrated network link device to the routing apparatus 102. It will be appreciated that in some deployments, the system 100 may comprise a mixture of one or more network link devices 114 physically coupled to the routing apparatus 102 (e.g., a network link device(s) physically coupled by way of wired connection and/or a network link device(s) integrated into the routing apparatus 102) and one or more mesh-enabled network link devices.

The routing apparatus 102 may be configured to provide DHCP service to end-user devices on the network, designating itself as the default gateway to the external network 118. End-user devices may accordingly route their outbound traffic destined for a destination accessible via the external network 118 to the routing apparatus 102 over the mesh network. The routing apparatus 102 may divide the traffic among the configured network link device(s) via which a connection to the external network 118 is available, and route the outbound traffic toward the selected network link device 114 for delivery to the intended destination via the external network 118.

The routing apparatus 102 may accordingly be configured in some example embodiments to make use of whatever assortment of back-haul connections to the external network 118 may be available via the network link device(s) 114 to which the routing apparatus 102 is interfaced. If multiple connections are available via the network link device(s) 114, the routing apparatus 102 may be configured to perform failover, load balancing, and/or routing of outbound traffic based at least in part on one or more routing policies, as will be described further herein below. Accordingly, it will be appreciated that in accordance with some example embodiments, the routing apparatus 102 and network link device(s) 114 may provide a bridge 120 between a wireless mesh network and the external network 118.

It will be appreciated that in some example embodiments, the external network 118 may comprise a conglomeration of a plurality of networks. For example, the external network 118 may comprise a combination of the Internet and one or more access networks (for example, one or more cellular access networks). Accordingly, respective network link devices 114 that may use different network access technologies may establish a connection to the external network 118 via different respective access networks.

In some example embodiments, there may be multiple external networks 118. In this regard, in some example embodiments, a first network link device 114 may be configured to establish a connection to a first external network, and a second network link device 114 may be configured to establish a connection to a second external network.

In some example deployments, multiple bridges 120 may be deployed for a mesh network. In this regard, a mesh network may be interfaced with multiple routing apparatuses 102, each of which may be interfaced with one or more network link devices 114. Such deployments may, for example, be used in larger facilities or larger scale deployments to avoid loss of connectivity to the external network 118 in the event a mesh network becomes split into two, such as due to a loss of connection between two mesh nodes that may bridge the extremities of the mesh network. Thus, for example, a first bridge 120 may be deployed at a first physical position within the mesh network deployment area, and a second bridge 120 may be deployed at a second physical position within the mesh network deployment area to provide redundancy in case mesh connectivity is lost between portions of the mesh network.

Having now generally described the components, configuration, and operation of the system 100 in accordance with several example embodiments, routing operations that may be performed by the routing apparatus 102 in accordance with various example embodiments will now be described. In this regard, the routing controller 220 may be configured to perform routing of inbound and outbound traffic in accordance with one or more configured routing policies.

In order to support routing services that may be provided by the routing apparatus 102, the routing controller 220 of some example embodiments may be configured to monitor the status of the system 100. For example, in some example embodiments, the routing controller 220 may be configured to monitor connections to the external network 118 that may be available via the network link device(s) 114 with which the routing apparatus 102 may be interfaced. Accordingly, the routing controller 220 may be configured to determine whether a connection to the external network 118 is currently available via an interfaced network link device 114. The routing controller 220 may be further configured to determine the health of a connection to the external network 118, such as by monitoring a signal strength quality of the connection, bandwidth available via the connection, a current data rate of data transmitted over the connection, and/or the like. For example, the routing controller 220 may be configured to monitor ping results over a connection to detect possible mesh or external network link packet loss or intermittent connections to the external network 118.

In some example embodiments, the routing apparatus 102 may be configured to provide a graphical user interface indicating a monitored network status. This graphical user interface may, for example, comprise a web interface that may be accessed at a designated address (for example, http://192.168.10.1) by a network connected device. Accordingly, a user may view a graphical interface that may be provided by the routing apparatus 102 to view the monitored network status in real-time. In some example embodiments, the graphical interface may show the availability and health of the network link devices 114. For example, the graphical interface may present a list of all network link devices 114 known to the routing apparatus 102 with their status. Network link devices 114 which are configured on, or otherwise known to, the routing apparatus 102, but which are not currently visible to the routing apparatus 102 may be color coded (e.g., red) and/or displayed with appropriate warning messages to indicate the status. Network link devices 114 that are visible to the routing apparatus 102 and which are currently being used by the routing apparatus 102 for accessing the external network(s) 118 may be color coded (e.g., green) to indicate the status. Network link devices 114 which visible to the routing apparatus 102, but through which connectivity to the external network 118 is currently unreachable or unreliable may be color coded (e.g., orange) and/or displayed with appropriate warning messages to indicate the status.

In some example embodiments, the routing controller 220 may be configured to perform failover from a first network link device 114 (e.g., a preferred network link device) to a second network link device 114 (e.g., a fallback network link device) based at least in part on monitored network conditions. In this regard, if a network link device fails or does not demonstrate an acceptable level of performance, the routing controller 220 may failover to another network link device.

For example, in an instance in which a connection to the external network 118 satisfying a defined threshold performance level is not available via the preferred network link device, the routing controller 220 may be configured to fail over to the fallback network link device and route outbound traffic toward the fallback network link device. The threshold performance level may comprise any predefined threshold performance level, and may be defined in terms of any appropriate metric. For example, the threshold performance level may be defined in terms of a minimum throughput for a connection.

As another example, the threshold performance level may be that a connection to the external network 118 is actually available via a given network link device. Thus, in this example, if a connection is available via the preferred network link device, the routing controller 220 may be configured to route outbound traffic toward the preferred network link device. However, if a connection to the external network 118 is not available via the preferred network link device, the routing controller 220 may be configured to fail over to a fallback network link device and route outbound traffic toward the fallback network link device.

The fail over behavior of some example embodiments may enable the routing apparatus 102 to provide access to an external network 118 via whatever network provider and/or access technology through which access to the external network 118 may be available in an area in which an embodiment of the system 100 is deployed. Thus, even when coverage through a particular wireless network provider and/or wireless access technology is not available in an area of deployment, the routing apparatus 102 may route traffic over the working network link device(s) 114 configured to establish a connection to the external network 118 via a network provider(s) and/or access technology through which access is available in the area of deployment. Accordingly, for example, if a particular access technology (for example, 4G cellular access) is preferred to a secondary access technology (for example, 3G cellular access) due to higher bandwidth, but coverage via the preferred access technology is not available, the routing controller 220 may be configured to fail over to the secondary access technology to obtain access to the external network 118.

In some example embodiments, if connections to an external network 118 are available via multiple network link devices 114, the routing controller 220 may be configured to select a network link device toward which to route outbound traffic from the network link devices 114 via which a connection to the external network 118 is available based at least in part on one or more routing policies.

In some example embodiments, the routing controller 220 may be configured to implement a load balancing policy to balance the load of outbound traffic among the available connections. For example, the routing controller 220 may be configured to route outbound traffic in a round robin fashion among the network link devices 114 via which a connection to the external network 118 is available. As another example, the routing controller 220 may be configured to route certain percentages of outbound traffic to particular network link devices 114. For example, 60% of outbound traffic may be routed to a first network link device; 20% of outbound traffic may be routed to a second network link device; and 20% of outbound traffic may be routed to a third network link device.

In some example embodiments, the routing controller 220 may be configured to route outbound traffic via a preferred network link device 114 so long as a connection to the external network 118 is available via the preferred network link device 114. For example, a connection to the external network 118 may be available via a first network link device using a first network access technology (for example, 4G cellular access), and a connection to the external network 118 may be available via a second network link device using a second network access technology (for example, 3G cellular access). The first network access technology may offer faster data transfer rates and/or more bandwidth than the second wireless access technology. In accordance with some example embodiments, the routing controller 220 may be configured to select the first network link device for routing outbound traffic to the external network 118 over the second network link device so long as a connection to the external network 118 is available via the first network link device due to the faster data transfer rates and/or greater bandwidth offered by the first wireless access technology.

In some example embodiments, the routing controller 220 may be configured to additionally or alternatively select a network link device 114 toward which to route outbound traffic based at least in part on a routing policy associated with a destination of the outbound traffic. In this regard, a particular destination address may be associated with a preferred network link device 114. For example, a destination address known to be associated with high priority data traffic, high bandwidth data traffic and/or the like may be associated with a routing policy preferring a network link device 114 offering a relatively high bandwidth connection to the external network 118. As another example, a destination address may be associated with a routing policy requiring or preferring a connection offering at least a threshold performance level, and the routing controller 220 may be configured to select a network link device 114 in accordance with the routing policy based at least in part on a monitored connection status. Accordingly, the routing controller 220 may be configured in some example embodiments to examine outbound traffic to determine the destination and, if that destination is associated with a routing policy, may select a network link device 114 in accordance with the associated routing policy.

In some example embodiments, the routing controller 220 may be configured to additionally or alternatively select a network link device 114 toward which to route outbound traffic based at least in part on a routing policy associated with a source of the outbound traffic. In this regard, a particular source address may be associated with a preferred network link device 114. For example, a source address known to be associated with high priority data traffic, high bandwidth data traffic and/or the like may be associated with a routing policy preferring a network link device 114 offering a relatively high bandwidth connection to the external network 118. As another example, a source address may be associated with a routing policy requiring or preferring a connection offering at least a threshold performance level, and the routing controller 220 may be configured to select a network link device 114 in accordance with the routing policy based at least in part on a monitored connection status. Accordingly, the routing controller 220 may be configured in some example embodiments to examine outbound traffic to determine the source of the traffic and, if that source is associated with a routing policy, may select a network link device 114 in accordance with the associated routing policy.

In some example embodiments, the routing controller 220 may be configured to additionally or alternatively select a network link device 114 toward which to route outbound traffic based at least in part on a routing policy associated with a data type of the outbound traffic. In this regard, data types requiring higher bandwidth and/or data types considered to be of importance may be associated with a routing policy requiring or preferring a particular network link device 114, a connection offering at least a threshold performance level, and/or the like. For example, real-time streaming video traffic, such as may be used in video conferencing may be associated with a routing policy preferring a network link device 114 configured to access the external network 118 via a network access technology offering faster data transfer rates (for example, a 4G cellular connection), preferring a connection offering at least a threshold performance level, and/or the like. On the other hand, in some example embodiments, data types that are not time sensitive in terms of delivery, that do not require high bandwidth, and/or otherwise do not require a certain quality of service level may be associated with a routing policy preferring a slower connection (for example, a 3G cellular connection). Accordingly, the routing controller 220 may be configured in some example embodiments to examine outbound traffic to determine a data type of the traffic and, if that data type is associated with a routing policy, may select a network link device 114 in accordance with the associated routing policy. In some example embodiments wherein a data type is associated with a routing policy preferring or requiring a connection offering a threshold performance level, the routing controller 220 may be configured to select a network link device 114 in accordance with the routing policy based at least in part on a monitored connection status.

In some example embodiments, the routing controller 220 may be configured to provide Network Address Translation (NAT) masquerading services for inbound and/or outbound traffic. More particularly, in some example embodiments, the routing controller 220 may be configured to apply NAT to outbound traffic to mask an address associated with an origin of the outbound traffic, such as with an address of the routing apparatus 102. The routing controller 220 may be further configured to apply NAT to inbound traffic to reveal an address associated with a destination of the inbound traffic (for example, by replacing the address of the routing apparatus 102 in an inbound data packet with the address of the actual destination) to enable the inbound traffic to be delivered to the destination via the mesh network.

In this regard, the routing controller 220 may be configured in some example embodiments to implement NAT masquerading on behalf of end-user devices with outbound traffic such that if inbound traffic related to that outbound traffic is received, it will be routed via the routing apparatus 102. Accordingly, in some example embodiments, NAT may be applied so that inbound traffic may be automatically routed via the routing apparatus 102 without having to configure routing tables of implemented network link devices 114.

In some example embodiments, outbound traffic sent over the external network 118 may be double NAT masqueraded. In this regard, a network link device 114 in accordance with some example embodiments may also be configured to apply NAT techniques to data traffic passed through the network link device.

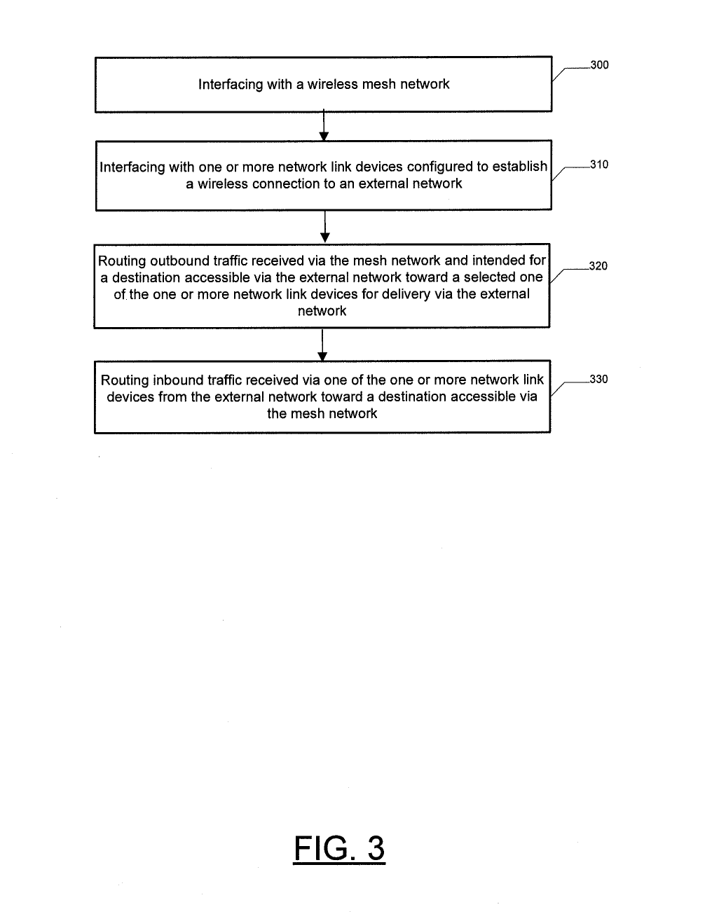

Referring now to FIG. 3, FIG. 3 illustrates a flowchart according to an example method for bridging a wireless mesh network and an external network according to some example embodiments. In this regard, FIG. 3 illustrates operations that may be performed at a routing apparatus 102. The operations illustrated in and described with respect to FIG. 3 may, for example, be performed by, with the assistance of, and/or under the control of one or more of the processing circuitry 210, processor 212, memory 214, communication interface 218, or routing controller 220. Operation 300 may comprise interfacing with a wireless mesh network. The processing circuitry 210, processor 212, memory 214, communication interface 218, and/or routing controller 220 may, for example, provide means for performing operation 300. Operation 310 may comprise interfacing with one or more network link devices (e.g., one or more network link devices 114) configured to establish a wireless connection to an external network (e.g., the external network 118). The processing circuitry 210, processor 212, memory 214, communication interface 218, and/or routing controller 220 may, for example, provide means for performing operation 310. Operation 320 may comprise routing outbound traffic received via the mesh network and intended for a destination accessible via the external network toward a selected one of the one or more network link devices for delivery via the external network. The processing circuitry 210, processor 212, memory 214, communication interface 218, and/or routing controller 220 may, for example, provide means for performing operation 320. Operation 330 may comprise routing inbound traffic received via one of the one or more network link devices from the external network toward a destination accessible via the mesh network. The processing circuitry 210, processor 212, memory 214, communication interface 218, and/or routing controller 220 may, for example, provide means for performing operation 330.

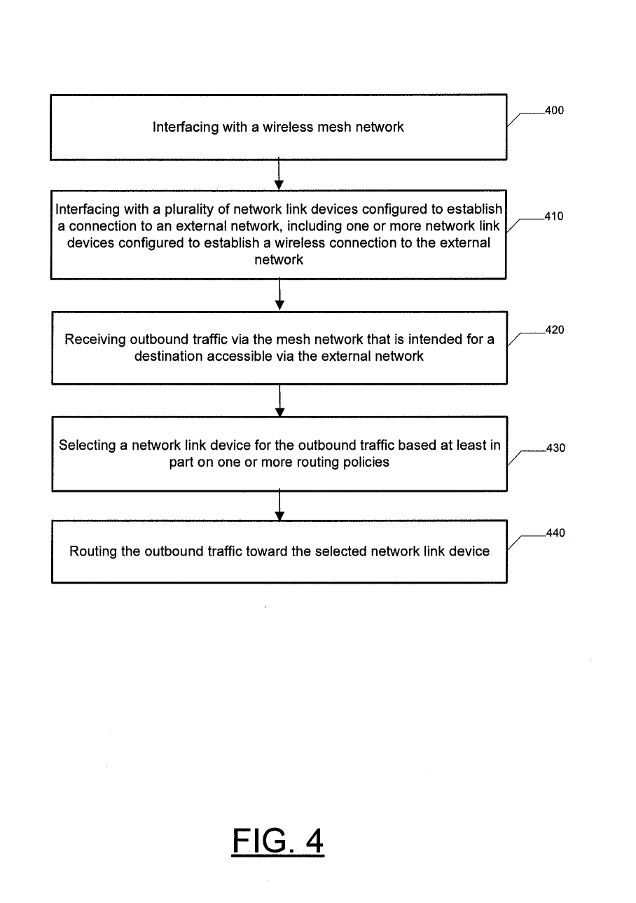

Referring now to FIG. 4, FIG. 4 illustrates a flowchart according to an example method for routing outbound traffic according to some example embodiments. In this regard, FIG. 4 illustrates operations that may be performed at a routing apparatus 102. The operations illustrated in and described with respect to FIG. 4 may, for example, be performed by, with the assistance of, and/or under the control of one or more of the processing circuitry 210, processor 212, memory 214, communication interface 218, or routing controller 220. Operation 400 may comprise interfacing with a wireless mesh network. The processing circuitry 210, processor 212, memory 214, communication interface 218, and/or routing controller 220 may, for example, provide means for performing operation 400. Operation 410 may comprise interfacing with a plurality of network link devices (e.g., a plurality of network link devices 114) configured to establish a connection to an external network (e.g., the external network 118), including one or more network link devices (e.g., one or more network link devices 114) configured to establish a wireless connection to the external network. In this regard, operation 410 may, for example, comprise interfacing with a plurality of network link devices including one or more devices configured to establish a wireless connection to the external network and one or more network link devices configured to establish a wired connection to the external network. Alternatively, for example, operation 410 may comprise interfacing with a plurality of network link devices including only link devices configured to establish a wireless connection to the external network. The processing circuitry 210, processor 212, memory 214, communication interface 218, and/or routing controller 220 may, for example, provide means for performing operation 410. Operation 420 may comprise receiving outbound traffic via the mesh network that is intended for a destination accessible via the external network. The processing circuitry 210, processor 212, memory 214, communication interface 218, and/or routing controller 220 may, for example, provide means for performing operation 420. Operation 430 may comprise selecting a network link device for the outbound traffic based at least in part on one or more routing policies. In some example embodiments, this selection may be made based at least in part on a monitored status of one or more connections to the external network available via the plurality of network link devices. The processing circuitry 210, processor 212, memory 214, and/or routing controller 220 may, for example, provide means for performing operation 430. Operation 440 may comprise routing the outbound traffic toward the selected network link device. The processing circuitry 210, processor 212, memory 214, communication interface 218, and/or routing controller 220 may, for example, provide means for performing operation 440.

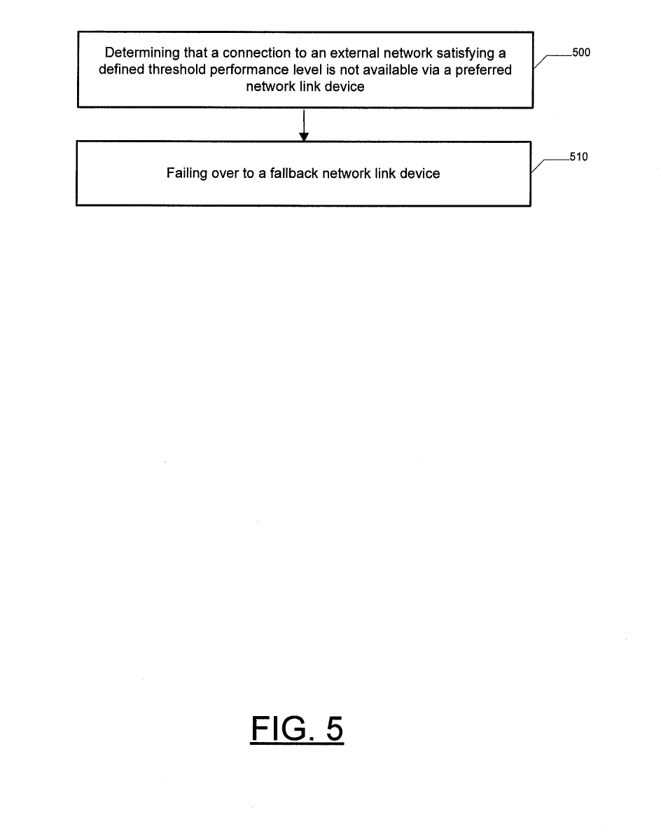

Referring now to FIG. 5, FIG. 5 illustrates a flowchart according to an example method for performing fail over according to some example embodiments. In this regard, FIG. 5 illustrates operations that may be performed at a routing apparatus 102. The operations illustrated in and described with respect to FIG. 5 may, for example, be performed by, with the assistance of, and/or under the control of one or more of the processing circuitry 210, processor 212, memory 214, communication interface 218, or routing controller 220. Operation 500 may comprise determining that a connection to an external network (e.g., the external network 118) satisfying a defined threshold performance level is not available via a preferred network link device (for example, a preferred network link device 114). The processing circuitry 210, processor 212, memory 214, communication interface 218, and/or routing controller 220 may, for example, provide means for performing operation 500. Operation 510 may comprise failing over to a fallback network link device responsive to the determination of operation 500. The processing circuitry 210, processor 212, memory 214, communication interface 218, and/or routing controller 220 may, for example, provide means for performing operation 510.

FIGS. 3-5 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a routing apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a routing apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for bridging a wireless mesh network and an external network, the method comprising:
interfacing with the wireless mesh network;
interfacing with one or more network link devices configured to establish a wireless connection to the external network;
routing, by processing circuitry, outbound traffic received via the mesh network and intended for a destination accessible via the external network toward a selected one of the one or more network link devices for delivery via the external network; and
routing, by the processing circuitry, inbound traffic received via one of the one or more network link devices from the external network toward a destination accessible via the mesh network.

2. The method of claim 1, wherein interfacing with one or more network link devices comprises interfacing with one or more cellular bridge devices.

3. The method of claim 1, wherein interfacing with one or more network link devices comprises interfacing with a plurality of network link devices comprising a preferred network link device and a fallback network link device, the method further comprising, in an instance in which a connection to the external network satisfying a defined performance level is not available via the preferred network link device, failing over to the fallback network link device and routing the outbound traffic toward the fallback network link device.

4. The method of claim 1, wherein interfacing with one or more network link devices comprises interfacing with a plurality of network link devices, the method further comprising selecting a network link device from the plurality of network link devices for the outbound traffic based at least in part on one or more routing policies.

5. The method of claim 4, wherein in an instance in which connections to the external network via a first network link device configured to establish a wireless connection to the external network via a first wireless access technology and via a second network link device configured to establish a wireless connection to the external network via a second wireless access technology are available, the first wireless access technology providing faster data transfer rates than the second wireless access technology, selecting a network link device for the outbound traffic comprises selecting the first network link device.

6. The method of claim 4, wherein selecting a network link device based at least in part on one or more routing policies comprises selecting a network link device based at least in part on a routing policy associated with one or more of the destination of the outbound traffic or an origin of the outbound traffic.

7. The method of claim 4, further comprising determining a data type associated with the outbound traffic, and wherein selecting a network link device based at least in part on one or more routing policies comprises selecting a network link device based at least in part on a routing policy associated with the determined data type.

8. The method of claim 4, wherein selecting a network link device comprises selecting a network link device based at least in part on a load balancing policy.

9. The method of claim 4, further comprising monitoring a status of one or more connections to the external network available via the plurality of network link devices, and wherein selecting a network link device from the plurality of network link devices for the outbound traffic based at least in part on one or more routing policies comprises selecting a network link device based at least in part on the monitored status.

10. The method of claim 1, further comprising:
applying network address translation to the outbound traffic to mask an address associated with an origin of the outbound traffic; and
applying network address translation to the inbound traffic to reveal an address associated with the destination of the inbound traffic to enable the inbound traffic to be delivered to the destination via the mesh network.

11. The method of claim 1, further comprising:
interfacing with one or more network link devices configured to establish a wireline connection to the external network; and
selecting network link device from the one or more network link devices configured to establish a wireless connection to the external network and the one or more network link devices configured to establish a wireline connection to the external network for the outbound traffic.

12. A computer program product for bridging a wireless mesh network and an external network, the computer program product comprising at least one non-transitory computer-readable medium having computer-readable program instructions stored therein, the computer-readable program instructions comprising instructions configured to cause an apparatus to at least perform:
interfacing with the wireless mesh network;
interfacing with one or more network link devices configured to establish a wireless connection to the external network;
routing outbound traffic received via the mesh network and intended for a destination accessible via the external network toward a selected one of the one or more network link devices for delivery via the external network; and
routing inbound traffic received via one of the one or more network link devices from the external network toward a destination accessible via the mesh network.

13. An apparatus for bridging a wireless mesh network and an external network, the apparatus comprising processing circuitry configured to cause the apparatus to at least:
interface with the wireless mesh network;
interface with one or more network link devices configured to establish a wireless connection to the external network;
route outbound traffic received via the mesh network and intended for a destination accessible via the external network toward a selected one of the one or more network link devices for delivery via the external network; and
route inbound traffic received via one of the one or more network link devices from the external network toward a destination accessible via the mesh network.

14. The apparatus of claim 13, further comprising a communication interface configured to wirelessly interface with the wireless mesh network, wherein the processing circuitry is configured to cause the apparatus to interface with the wireless mesh network via the communication interface.

15. The apparatus of claim 13, wherein the one or more network link devices comprise one or more cellular bridge devices.

16. The apparatus of claim 13, wherein the processing circuitry is further configured to cause the apparatus to interface with one or more network link devices at least in part by interfacing with a network link device via the wireless mesh network.

17. The apparatus of claim 13, wherein the processing circuitry is further configured to cause the apparatus to interface with one or more network link devices at least in part by interfacing with a network link device physically coupled to the apparatus.

18. The apparatus of claim 13, wherein the processing circuitry is further configured to cause the apparatus to:
interface with one or more network link devices at least in part by interfacing with a plurality of network link devices comprising a preferred network link device and a fallback network link device; and
in an instance in which a connection to the external network satisfying a defined performance level is not available via the preferred network link device, fail over to the fallback network link device and route the outbound traffic toward the fallback network link device.

19. The apparatus of claim 13, wherein the processing circuitry is further configured to cause the apparatus to:
interface with a plurality of network link devices; and
select a network link device from the plurality of network link devices for the outbound traffic based at least in part on one or more routing policies.

20. The apparatus of claim 19, wherein the processing circuitry is further configured to cause the apparatus to:
monitor a status of one or more connections to the external network available via the plurality of network link devices; and
select a network link device from the plurality of network link devices for the outbound traffic based at least in part on one or more routing policies at least in part by selecting a network link device based at least in part on the monitored status.

21. The apparatus of claim 13, wherein the processing circuitry is further configured to cause the apparatus to:
apply network address translation to the outbound traffic to mask an address associated with an origin of the outbound traffic; and
apply network address translation to the inbound traffic to reveal an address associated with the destination of the inbound traffic to enable the inbound traffic to be delivered to the destination via the mesh network.

22. A system for providing network connectivity comprising:
a plurality of wireless mesh nodes configured to form a wireless mesh network;
one or more network link devices configured to establish a wireless connection to an external network; and
a routing apparatus;
wherein the routing apparatus is configured to at least:
interface with the wireless mesh network;
interface with the one or more network link devices;
route outbound traffic received via the mesh network and intended for a destination accessible via the external network toward a selected one of the one or more network link devices for delivery via the external network; and
route inbound traffic received via one of the one or more network link devices from the external network toward a destination accessible via the mesh network.

23. The system of claim 22, wherein the plurality of wireless mesh nodes comprises a wireless mesh node configured to repeat, over the wireless mesh network, data traffic received via the wireless mesh network.

24. The system of claim 22, wherein the plurality of wireless mesh nodes comprises a wireless mesh node configured to interface with the wireless mesh network and to provide a structured wireless local area network access point for one or more client computing devices to enable the client computing devices to send and receive data over the wireless mesh network via a wireless local area network connection to the wireless local area network access point.

25. The system of claim 22, wherein the routing apparatus is embodied on one of the plurality of wireless mesh nodes.
